(19) United States
(12) Patent Application Publication
(10) Pub. No.: US 2002/0155139 A1
(43) Pub. Date: Oct. 24, 2002

(54) Molluscicidal method and material

(75) Inventors: William Feiler, La Habra Heights, CA (US); Kevin Brady, Hacienda Heights, CA (US); Joseph Synek, Overland Park, KS (US)

Correspondence Address: Mr. Richard H. Zaitlen, PILLSBURY WINTHROP LLP, Suite 2800, 725 South Figueroa Street, Los Angeles, CA, 90017, US

(73) Assignee: AMVAC Chemical Corporation.

(21) Appl. No.: 09/839,557

(22) Filed: Apr. 20, 2001

(51) Int. Cl. A01N 25/00; A01N 25/34; A01N 25/08; A01N 25/26; A01N 25/28; A01N 35/00

(52) U.S. Cl. 424/405; 424/408; 424/410; 424/417; 424/421; 424/84; 504/101; 71/64.13; 514/705; 523/122; 424/418

(57) ABSTRACT

A molluscicidal material having a predetermined size, composed of an interior core having predetermined properties, at least one adhesive, a mollusk attractant and a molluscicide coating, and the process of treating plants and mollusks with the same.

### FIELD OF THE INVENTION

The present invention relates generally to a versatile process and material that provide the benefits of a molluscicide and that may be adapted to provide the additional benefits of a chosen carrier, and more specifically to a process and material for controlling snail and slug populations that may be selectively designed to provide at least one additional benefit.

### BACKGROUND OF THE INVENTION

Slugs and snails cause much damage to agricultural crops and other plants throughout many parts of the world. They thrive in the same type of moist, temperate conditions in which many agricultural products thrive. If not controlled, their potential for damage to agricultural crops and other plants is substantial.

It is known in the art to use various chemical molluscicidal compositions to reduce the population of slugs, snails and other mollusks in an area. For example, U.S. Pat. No. 6,093,416, to Young, discloses a stomach-action molluscicide comprising the metal complexone [Fe(OH)EDTA]²⁻ and a carrier. Other manufacturers use 2,4,6,8-tetramethyl-1,3,5,7-tetraoxycyclo-octane (metaldehyde) as a molluscicide. The most common forms for commercially available molluscicidal products are powders, particulates, granules and pellets.

One way to reduce the mollusk population in a given area is to distribute grains of sand or other particulates that have been coated with a molluscicide. These small particulates are useful for spreading the molluscicide evenly over a large area. These are very effective on smooth surfaces, e.g., flower beds, nurseries and other compacted growing sites. However, due to their small size, they may fall into cracks or crevices in the soil or other environmental structures. This can make a relatively high percentage of the grains inaccessible to the mollusks.

Another way known in the art to reduce the mollusk population in a given area is to distribute pellets composed of a molluscicide and an inert carrier or other filler material. Theoretically, the filler or carrier may be inert, so it does not harm (or benefit) the environment. In this formula, the pellets are formed from a homogeneous mixture of molluscicide and filler. Any given piece, or bite, of a pellet contains both filler and molluscicide.

These pellets may be designed in a variety of manners. For example, they may incorporate a relatively low percentage of molluscicide. This has the advantage of being comparatively environmentally friendly since it does not leave a larger concentration of molluscicide in the environment. The downside to this is that it may be less effective, since the mollusks have to consume a relatively large amount of the pellet in order to be affected by the molluscicide. Alternatively, the pellets may incorporate a higher dosage of molluscicide so that the snail or slug will be affected by the consumption of a smaller amount of the pellets. However, this method of controlling mollusks is more expensive due to the cost of the molluscicide agent. Further, it leads to the release of a significant amount of molluscicide into the environment. This is undesirable from an environmental standpoint. A means for delivering a relatively high concentration of molluscicide to the mollusks, while limiting the amount of molluscicide remaining in the environment, is desired.

It is known in the art to apply other materials to crops or plants. Such materials include insecticides, fertilizers, and worm-killers. These may be supplied in liquid form, either directly or through an irrigation system. Alternatively, these materials may be applied in solid form and may be scattered by hand, or by machine.

When scattering these solid materials, it is preferable that they be relatively small in size. For a material having relatively uniform density, as the size of the solid materials being applied increases, the number of individual particles being applied to a certain area necessarily (assuming application of the same amount of material) decreases. The smaller number of particles applied results in fewer sources of the material, which, in turn, each have a higher relative amount of the material. This may result in uneven application of the material, which could be toxic to the plant(s) in the area in which it is applied. The higher number of smaller particles, on the other had, provides more sources of the material, each having a smaller relative amount of the materials. This leads to a more even application of the material to a given area.

Individually, the application of each of the above products is a beneficial step that a grower can take to promote the life and health of his plants. However, caring for plants in such a devoted manner is somewhat time-consuming, since the individual applications are usually performed separately. For example, the user may apply a molluscicide and then apply a fertilizer, or visa-versa. Depending on the area to be covered, and the resources available, the farmer or other user may not be able to perform all desired tasks within the applicable time frame or within the cost structure required for maintaining adequate profit margins for continuing to produce quality products.

It is generally not possible to evenly apply two different types of particles to a given area simultaneously, since the different types of particles will almost always have different sizes, densities and weights. This is true, even if the particles are mixed together in a heterogeneous mixture. Any mechanism that distributes, or throws, the products is likely to throw the heavier particles farther, and the lighter particles a shorter distance. This will lead to an unequal distribution of particles. As such, some areas will receive an extra dose of the first product, and too little of the second product, and others will receive an extra dose of the second product, and too little of the first product. This is detrimental since the application of too much of one product to an area may actually be detrimental to the plants growing there, while too little of a product will not provide the intended benefit to the plant. Under these circumstances, it is not preferable to apply such a heterogeneous mixture of two products simultaneously. However, it is highly desirable to apply more than one product at a time. Reasons for this method of application include: labor cost savings for the grower; potential advantages in the number of equipment needed by the grower; and potential advantages to the plants by the simultaneous application of multiple materials which can protect and promote growth.

### BRIEF DESCRIPTION OF THE FIGURES

FIG. 1 is a graph showing the percent mortality versus the days of exposure to the invention; and

FIG. 2 is a graph showing the percent plant damage versus the days of exposure to the invention.

### DETAILED DESCRIPTION OF THE PREFERRED EMBODIMENTS

The present invention is a product and process by which a user may simultaneously fight mollusk infestation and provide at least one additional benefit to his plants or crops. The product of the present invention is a plurality of particles, each of which is comprised of an internal core and an external molluscicide coating.

The placement of the molluscicide in a coating around a core provides the unexpected benefit of providing a product that has an increased ability to control mollusk populations with the same amount of molluscicide content. Since the molluscicide is contained in the coating, the snail or slug, which will first encounter and ingest the coating, will ingest a relatively high percentage of the molluscicide. Since the mollusk ingests a lethal amount when it ingests the coating, additional molluscicide in the core of the invention would be superfluous. The rest of the particle, and the particles that are not consumed by snails or slugs, may serve a beneficial purpose such as fertilization or other desirable function when they are carried into the soil by rain or irrigation, or are otherwise incorporated in the soil.

The core of the present invention also provides an unexpected benefit. By partitioning the molluscicide and placing it on the exterior of the product, where it can be the most effective, the present invention allows for the inclusion of material, in the form of a core, which may also be beneficial to the plants or area being treated. An incompletely consumed particle, and any particles that are not consumed by snails or slugs, may serve the purpose that was designated when the type of core was selected. For example, if the core was selected from a group of fertilizers, then the particles will act as a fertilizer when they are carried into the soil by rain or irrigation. The material of the core generally does not mix with the molluscicidal coating, so there is little risk of chemical interaction between the core and the molluscicide. Further, since the core of the present invention may be chosen from a separate group of beneficial materials, the manufacturer may design and produce a product using ingredients with similar characteristics. Ingredients having similar characteristics may be readily used together in the same product, and applied concurrently to plants. This allows for a product that will provide, in one application, an appropriate amount of molluscicide and a beneficial amount of a second ingredient. This overcomes the difficulties associated with simultaneously scattering two different particles that were encountered in the prior art. Since the particles generally have the same characteristics, the even distribution of the combination of products will provide the desired even scattering of the materials.

Materials which may be included in the core include, but are not limited to, fertilizers, micronutrients, and pesticides. Examples of micronutrients include, but are not limited to, trace elements such as boron, manganese, iron and molybdenum. For the purposes of this application, the term “fertilizer” shall be broadly read to include such micronutrients.

The core may be any material or materials as are known in the art. Preferably, the core is chosen to best suit the needs of the plants or crops being treated. For example, a fertilizing core may be chosen to enrich the soil in which the plants are growing. Alternatively, an inert core may be chosen. This will provide the molluscicide to the plants with minimal environmental impact, and may disintegrate and/or become incorporated with the soil. It should be understood that the core of the present invention may be composed of one or more products, depending on chemical compatibility. The core of the invention is preferably from 20 to 97 percent by weight of the particle, and most preferably from 71 to 97 percent by weight of the particle.

When the present invention is utilized, the molluscicide coating will act to kill any mollusk that consumes the product. The product may also stick to mollusks that contact it, thereby increasing exposure to, and hence toxicity of, the molluscicide. The product that is not consumed by mollusks may act in the manner for which the core was chosen—for example, it may serve as a worm killer, or a fertilizer.

In accordance with the present invention, soil and plants are treated by scattering an effective amount of the present invention evenly throughout the area being treated. Such an amount may be determined based on the amount of molluscicide required to reduce the population of mollusks and/or on the amount of the product contained in the core of the invention that is desired for the predetermined area of soil.

The present invention takes the form of a plurality of particles, which may be generally round. The particles of the present invention preferably range from 0.5 inch to 40 mesh in size, more preferably from 0.5 inch to 24 mesh in size, and most preferably from 4 to 12 mesh in size. Each particle is generally composed of a molluscicide, an adhesive, an attractant and a core. It has been found that mollusks such as snails and slugs will be attracted to, and actively feed on, these particles. Further, these particles have been found to adhere to the bodies of mollusks, thus increasing the exposure of the mollusks to the molluscicide and allowing the molluscicidal action of the particles to continue even after the mollusk has stopped eating.

In contrast to the granular particles of the prior art, the particle size of the present invention permits the molluscicide fertilizing material to be dispersed evenly over the ground surface, without suffering the same fate as the smaller particles of molluscicide that are known in the art. The particles of the present invention are sufficiently large such that they will not fit into particularly small crevices. If the particles fall into a crack or crevice, it is highly likely that the crevice will be of sufficient size to allow the mollusks to access the particles. The attractant will encourage mollusks in their attempts to do so. The small, granular, particles that are taught in the art are of such diminutive size that they are likely to fall into tiny cracks and crevices, rendering them inaccessible to mollusks.

The particles of the present invention are also not excessively large. Distribution of large particles may result in localized areas of extreme concentration of the molluscicide, and areas that are not treated with sufficient molluscicide. The size of the present invention is small enough to allow for a sufficiently high number of particles so that the mollusks are more likely to encounter, or be attracted to, the particles. Further, the particles of the present invention are sufficiently small so that even disbursement over the area being treated results in distribution of the invention in a manner that is both lethal to mollusks and beneficial to plants.

These particles may be dispersed over the area to be treated in any manner as is known in the art. Such dispersal may be performed mechanically or, in smaller areas, by hand.

The particles of the present invention consist of a “core” surrounded by an attractant, an adhesive and a molluscicide. The exact ordering of the components of the present invention is not critical, so long as the molluscicide is on the exterior of the particle. The core may be composed of any suitable material that may be chosen by the manufacturer of the present invention, but preferably is a fertilizer. The fertilizer may be any suitable fertilizer as is known in the art. Preferably, the fertilizer is chosen based on the plant-life in the area to which the present invention is applied. For example, the fertilizer may be chosen to benefit a rose garden, or to benefit a farmer's crops. Such a choice of fertilizer allows the user to tailor the present invention to the needs of his plants or crops and to provide an improved method for applying the invention since it may be similar to other materials that he is applying to his plants or crops. Each particle may contain up to about 97 percent by weight fertilizer. The fertilizer may be carried into the soil by rain or irrigation, or may be subsequently incorporated into the soil by actions such as plowing.

The adhesive may be any as are known in the art. Examples of adhesives include, but are not limited to, starch-based adhesives, latex emulsions, dextrin, polyvinyl acetates, resins, and flour paste adhesives.

The mollusk attractant may be any attractant that is known in the art. For example, the attractant may be a material, particularly a plant material such as grass, and grass seeds. Mollusks are attracted to fruit, cabbage, herbs such as basil, tomatoes and potatoes. Mullusks are also particularly attracted to sugars and yeast. The attractant may be selected based on a known effect on a specific species of mollusks. Alternatively a more popular, or general attractant may be utilized.

The molluscicide is generally located in a coating that surrounds the core. It is attached to the core by an adhesive. The molluscicide is preferably metaldehyde (2,4,6,8-tetramethyl-1,3,5,7-tetraoxycyclo-octane), but may be any other appropriate molluscicide as is known in the art. Such molluscicides include, but are not limited to, iron phosphate and mesurol. Each particle may contain up to about 10 percent by weight molluscicide. Preferably, the particles contain from 1-8% by weight molluscicide, and most preferably, the particles contain 2-5% by weight molluscicide. The molluscicide coating generally coats the core, and may serve to fill in many of the particle's porous openings, if the core is porous. While this may delay the disintegration of the particle, the coating does not prevent the particles from disintegrating in the presence of water as may be required for absorption by the plants.

The placement of the molluscicidal agent on the exterior of the particles of the present invention allows a similar amount of molluscicide (as a percentage of total particle weight) to have the same or greater effect as compared to the amount of molluscicide that is mixed throughout a particle. This may be contrasted with the mixing of molluscicide with an inert carrier as is taught in the art, which causes the molluscicide to be located in the interior as well as on the exterior of a molluscicidal pellet. The molluscicide of the present invention is located exclusively on the exterior portion of the particle, and immediately accessible to the mollusk. Therefore, the molluscicidal product of the present invention will provide an increased rate of mollusk control as compared to the molluscicidal products known in the art.

The combination of ingredients is a beneficial timesaving feature of the present invention, since it not only allows users to determine and address two of the needs of their plants at the same time, but helps users in the application of those products. Without the present invention, given time and/or monetary constraints, may users may be tempted to only apply one plant treatment per season. In contrast, with just one application of the present invention, the user may both treat a pest problem and provide a second benefit, such as fertilization, to plants. The present invention may also serve to ensure that the plants receive the care that they require to be healthy and/or to produce plentiful amounts of food.

The following examples illustrate the invention.

### EXAMPLE

The molluscicidal activity of the material used in the method of the invention was tested using Cryptomphalus Aspersus as a test mollusk. The snails were collected from nearby fields. The test crop was lettuce, planted in clay/loam soil. The test plots had not been previously treated with molluscicides. The tests were run in 1-meter² boxes, which were fixed to the ground and sealed to prevent escapes. Once the boxes were set up, particles of the present invention containing a fertilizer core were scattered within each box.

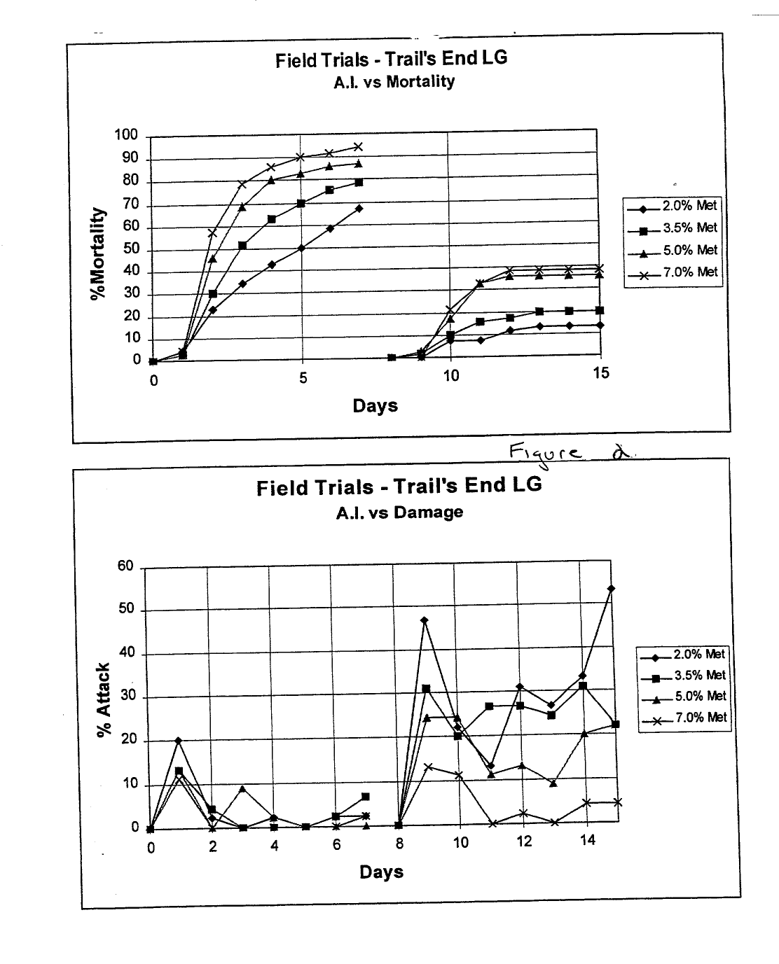

The snails were starved for 48 hours prior to the test. Each day, dead animals were removed from the cage. All animals were removed and replaced after 7 days. To obtain the results shown in FIG. 1, the test was replicated 5 times. Damage to the plants was assessed by observation of damage on 9 lettuce plants with 12 leaves planted in each box. Temperature and moisture were monitored during the test. On days of no rainfall, 0.5 centimeters of irrigation was applied to all boxes.

As may be seen from FIG. 1, there is a straightforward proportional response of increasing metaldehyde content to increasing mortality. Differences in the materials appear to be primarily in the rate at which the mollusks are killed. It appears that virtually all of the mollusks would have been killed had they not been removed and replaced with previously unexposed mollusks. As expected, there is an inverse relationship for crop damage versus percent mortality. See FIG. 2.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A molluscicidal material comprising a plurality of particles having a predetermined size, wherein the particles consist of:
an interior core, wherein the core is selected from the group consisting of: a fertilizer and a pesticide;
an adhesive disposed about the core; and
an exterior coating, wherein the coating comprises an attractant and a molluscicide.

2. The molluscicidal material as in claim 1, wherein the predetermined size of the particles is from 4 to 12 mesh.

3. The molluscicidal material as in claim 1, wherein the predetermined size of the particles is from 0.5 inch to 24 mesh.

4. The molluscicidal material as in claim 1, wherein the predetermined size of the particles is from 0.5 inch to 40 mesh.

5. The molluscicidal material as in claim 1, wherein the core is between 20 and 97 percent by weight of the particle.

6. The molluscicidal material as in claim 1, wherein the core is between 71 and 97 percent by weight of the particle.

7. The molluscicidal material as in claim 1, wherein the adhesive is selected from the group consisting essentially of: a starch based adhesive, a latex emulsion, dextrin, a polyvinyl acetate, a resin, and a flour paste adhesive.

8. The molluscicidal material as in claim 1, wherein the attractant will attract mollusks.

9. The molluscicidal material as in claim 1, wherein the molluscicide is 2,4,6,8-tetramethyl-1,3,5,7-tetraoxycyclo-octane.

10. The molluscicidal material as in claim 1, wherein a particle contains from 1 to 10 percent by weight 2,4,6,8-tetramethyl-1,3,5,7-tetraoxycyclo-octane.

11. The molluscicidal material as in claim 1, wherein a particle contains from 1 to 8 percent by weight 2,4,6,8-tetramethyl-1,3,5,7-tetraoxycyclo-octane.

12. The molluscicidal material as in claim 1, wherein a particle contains from 2 to 5 percent by weight 2,4,6,8-tetramethyl-1,3,5,7-tetraoxycyclo-octane.

13. A material comprising a plurality of particles having a predetermined size, wherein the material provides the benefit of a molluscicide and a fertilizer, wherein the particles consist of:
an interior fertilizer core;
an adhesive disposed about the core; and
an exterior coating, wherein the coating comprises an attractant and a molluscicide.

14. The material as in claim 13, wherein the predetermined size of the particles is from 4 to 12 mesh.

15. The material as in claim 13, wherein the predetermined size of the particles is from 0.5 inch to 24 mesh.

16. The material as in claim 13, wherein the predetermined size of the particles is from 0.5 inch to 40 mesh.

17. The material as in claim 13, wherein the core is between 20 and 97 percent by weight of the particle.

18. The material as in claim 13, wherein the adhesive is selected from the group consisting essentially of: a starch based adhesive, a latex emulsion, dextrin, a polyvinyl acetate, a resin, and a flour paste adhesive.

19. The material as in claim 13, wherein the attractant will attract mollusks.

20. The material as in claim 13, wherein the molluscicide is 2,4,6,8-tetramethyl-1,3,5,7-tetraoxycyclo-octane.

21. The material as in claim 13, wherein a particle contains from 1 to 10 percent by weight 2,4,6,8-tetramethyl-1,3,5,7-tetraoxycyclo-octane.

22. The material as in claim 13, wherein a particle contains from 1 to 8 percent by weight 2,4,6,8-tetramethyl-1,3,5,7-tetraoxycyclo-octane.

23. The material as in claim 13, wherein a particle contains from 2 to 5 percent by weight 2,4,6,8-tetramethyl-1,3,5,7-tetraoxycyclo-octane.

24. A material comprising a plurality of particles having a predetermined size, wherein the material provides the benefit of a molluscicide and a fertilizer, wherein the particles consist of:
a 20 to 97 percent by weight fertilizer core;
an adhesive disposed about the core; and
an exterior coating, wherein the coating comprises an attractant and 1 to 10 percent by weight 2,4,6,8-tetramethyl-1,3,5,7-tetraoxycyclo-octane coating.

25. The material as in claim 24, wherein the predetermined size of the particles is from 4 to 12 mesh.

26. The material as in claim 24, wherein the predetermined size of the particles is from 0.5 inch to 24 mesh.

27. The material as in claim 24, wherein the predetermined size of the particles is from 0.5 inch to 40 mesh.

28. The material as in claim 24, wherein the adhesive is selected from the group consisting essentially of: a starch based adhesive, a latex emulsion, dextrin, a polyvinyl acetate, a resin, and a flour paste adhesive.

29. The material as in claim 24, wherein the attractant will attract slugs mollusks.

30. A process of simultaneously treating an area with a molluscicide and a material that is beneficial to plants, wherein the process comprises:
selecting a particle having a predetermined size from the group consisting essentially of: fertilizers, and pesticides;
coating the particle with adhesive,
covering the coated particle with a second coating to create a particle having two coatings, wherein the second coating comprises an attractant and a molluscicide; and
distributing a plurality of the particles having two coatings in the area such that the coated particles are readily accessible to mollusks.

31. The process as in claim 30, wherein the predetermined size of the fertilizer particle is from 4 to 12 mesh.

32. The process as in claim 30, wherein the adhesive is selected from the group consisting essentially of: a starch based adhesive, a latex emulsion, dextrin, a polyvinyl acetate, a resin, and a flour paste adhesive.

33. The process as in claim 30, wherein the molluscicide of the molluscicidal coating is 2,4,6,8-tetramethyl-1,3,5,7-tetraoxycyclo-octane.

34. The process as in claim 30, wherein the molluscicidal coating includes an attractant.

35. The process as in claim 30, further including a watering step after the distributing step.

36. A process of treating an area with a material that has at least two beneficial effects, one of which is the effect of a molluscicide, wherein the process comprises:
selecting a particle having a predetermined size from the group consisting essentially of: fertilizers, and pesticides, such that the particle is from 20 to 97 percent by weight of a finished product;
coating the particle with adhesive,
covering the coated particle with a second coating, wherein the second coating comprises an attractant and a molluscicide; and
distributing the particles having two coatings in the area such that the coated particles are readily accessible to mollusks.

37. The process as in claim 36, wherein the predetermined size of the particle is from 4 to 12 mesh.

38. The process as in claim 36, wherein the particle is selected from the group consisting essentially of: fertilizers, and pesticides.

39. The process as in claim 36, wherein the adhesive is selected from the group consisting essentially of: a starch based adhesive, a latex emulsion, dextrin, a polyvinyl acetate, a resin, and a flour paste adhesive.

40. The process as in claim 36, wherein the molluscicide of the molluscicidal coating is 2,4,6,8-tetramethyl-1,3,5,7-tetraoxycyclo-octane.

41. The process as in claim 36, wherein the molluscicidal coating includes an attractant.

42. The process as in claim 36, further including a watering step after the distributing step.
